(19) United States
(12) Patent Application Publication
(10) Pub. No.: US 2017/0015260 A1
(43) Pub. Date: Jan. 19, 2017

(54) Apparatus And Method For Exchanging And Displaying Data Between Electronic Eyewear, Vehicles And Other Devices

(71) Applicant: LAFORGE Optical, Inc., Venice, CA (US)

(72) Inventors: Corey Mack, Venice, CA (US); William Kokonaski, Gig Harbor, WA (US)

(21) Appl. No.: 15/209,384

(22) Filed: Jul. 13, 2016

Related U.S. Application Data
(60) Provisional application No. 62/191,752, filed on Jul. 13, 2015.

(51) Int. Cl. B60R 16/023; B60W 40/08; B60R 1/00; B60R 16/037; G02B 27/01; H04N 5/232

(52) U.S. Cl. CPC B60R 16/0231; G02B 27/017; H04N 5/23293; B60R 1/00; B60R 16/037; B60W 40/08; G02B 2027/0141; G02B 2027/0138; G02B 2027/0178; B60W 2040/0809; B60R 2300/105; B60R 2300/20

(57) ABSTRACT

Disclosed are systems that allow for data to be shared between vehicles, locking mechanisms, and electronic eyewear. In an embodiment, a system includes a head-worn electronic eyewear device comprising a wireless communication module and an audio or visual system configured to communicate information received via the wireless module to a wearer of the head-worn electronic eyewear device. A vehicle module is configured to communicate wirelessly with the head-worn electronic eyewear device, either directly or through a third-party device, such that vehicle data is communicated to the wireless module of the head-worn electronic eyewear device for communication to the wearer of the head-worn electronic eyewear device. Systems for using a head-worn device to communicate settings data and to authenticating a user are also disclosed. A wireless-enabled device configured to utilize data from three or more sensors in a trilateration function to locate the second wireless-enabled device is further disclosed.

This application is a non-provisional of, and claims priority to, U.S. Provisional Application No. 62/191,752 filed Jul. 13, 2015, the entire disclosure of which is incorporated herein by reference.

### FIELD

The present invention relates in general to the field of mediated reality and in particular to a system and method that allows for data to be shared between vehicles, locking mechanisms, and electronic eyewear.

### BRIEF DESCRIPTION OF DRAWINGS

Objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows an illustration of an embodiment of the system of the invention, a vehicle and its subsystems.

FIG. 2 shows an alternate view of the system illustrating the invention, a vehicle and its subsystems.

FIG. 3 shows an illustration of the system in an embodiment wherein the invention interacts with more than one wireless device.

FIG. 4 shows a view of the components in the invention and components in other systems.

FIG. 5 shows an illustration of an embodiment wherein an image of the eye is used to authenticate.

FIGS. 6 and 6A show illustrations of an application wherein a distance is calculated using an embodiment of the invention.

FIG. 7 shows an illustration of the variables of a distance-finding application.

FIGS. 8 and 8A show illustrations of an operation of a distance finding application.

FIG. 9 shows an illustration of an output of a distance-finding operation from the prospective of the user.

FIG. 10 shows an illustration of a communication method.

FIG. 11 shows an illustration of an alternate communication method.

FIG. 12 illustrates a system in accordance with an embodiment of the invention.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices for exchanging and displaying data between electronic eyewear, vehicles and other devices. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

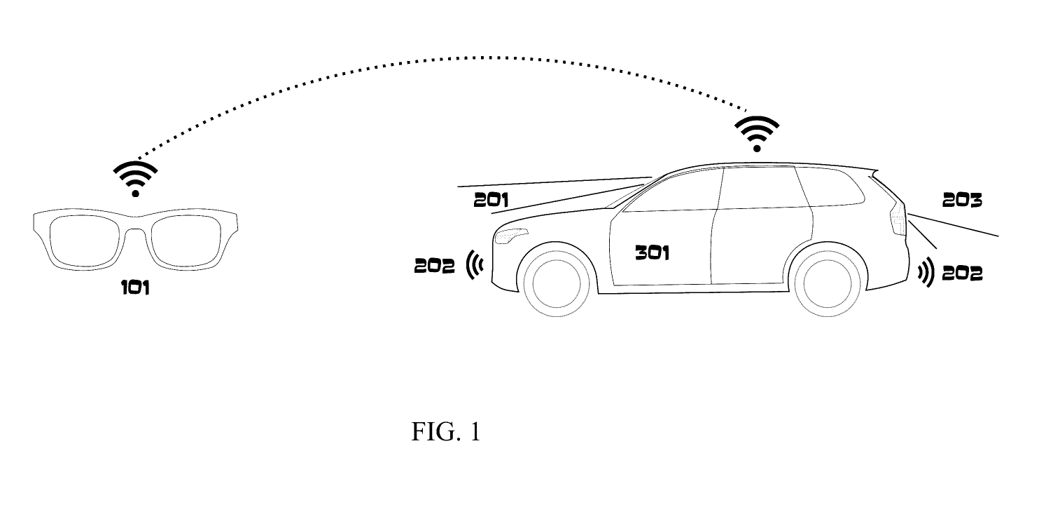

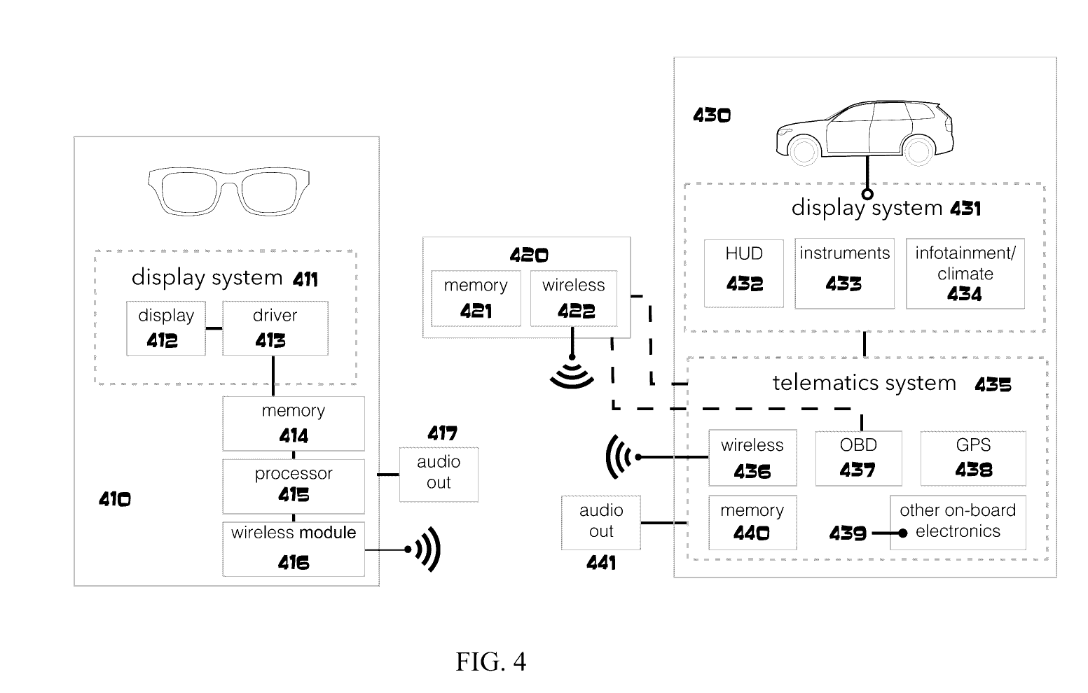

FIG. 1 shows an embodiment of the invention wherein a wirelessly enabled vehicle has external or external-facing sensors that are used to alert the driver to certain hazards. Electronic eyewear 101 is wirelessly connected to a vehicle 301 and has the ability to transmit and receive signals to other devices or mechanisms. In this embodiment the vehicle may consist of front and rear parking sensors 202. A front facing camera system 201 and a rear facing camera sensor 201 are provided. The data from 201, 202, and 203 may be obtained from an onboard telematics system 435 that engages with other on-board electronics 439 (FIG. 4). The outputs from the vehicle's telematics system are output via an audio system, and/or through one or more display systems 431 (FIG. 4). These types of displays may comprise, but are not limited to, an onboard head up display system 103 (also 432 in FIG. 4). 103 is typically a system in or on the dashboard that displays certain bits of telematics and navigation information in front of the driver via a virtual image that reflects of the windshield or, in the case of vehicles such as the 2015 Mini Cooper, a flip-up reflective element between the windshield and the steering wheel. The information may also be displayed in the instrument panel 104 that is behind the steering wheel and below the windshield. In some cars today, outputs from GPS 438 (FIG. 4) are also displayed in 104 as seen in the MMI system in vehicles such as the 2016 model year Audi TT, where traditional instrument cluster information such as speed, engine RPM, and warning lights among other outputs may displayed interchangeably or simultaneously with GPS data. Additional data can also be output the infotainment/climate system 102. 102 is usually located in the dashboard between the driver and passenger. 102 accepts inputs from occupants in the vehicle and can store settings and start functions such as vehicle settings 124, telephony settings 125, GPS location 123, comfort settings 122 such as HVAC and seat position, radio settings 121, and playlist 120.

In an embodiment, the system including the eyewear can interface with the above system and allow the wearer of the eyewear to not only view but also interface with this data wirelessly in a way that does not avert the driver's eyes downward or otherwise away from the road. Additionally, the system can relay other simpler forms of visual or audible alert to the driver exclusively. For example, Volvo's City Safe system is able to detect pedestrians, cyclists, and other vehicles and apply the brakes to avoid or lessen the severity of the impact. The interface to the driver (in addition to the sudden jerk of the vehicle coming to a stop) is an audible alert coupled with an array of flashing red lights below the windshield. In accordance with the invention, however, the system can reroute the audio signal from the vehicle's audio out port 441 to the electronic eyewear 101 so that the driver may hear via an audio out port 417 such as Piezo element mounted in the frame or via and aux port onboard 101. Similarly, the visible alert may be expanded from just a series of warning lights visible in system 411 of the electronic eyewear to a higher fidelity alert where the hazard has shape placed around it so that the driver may be even more informed.

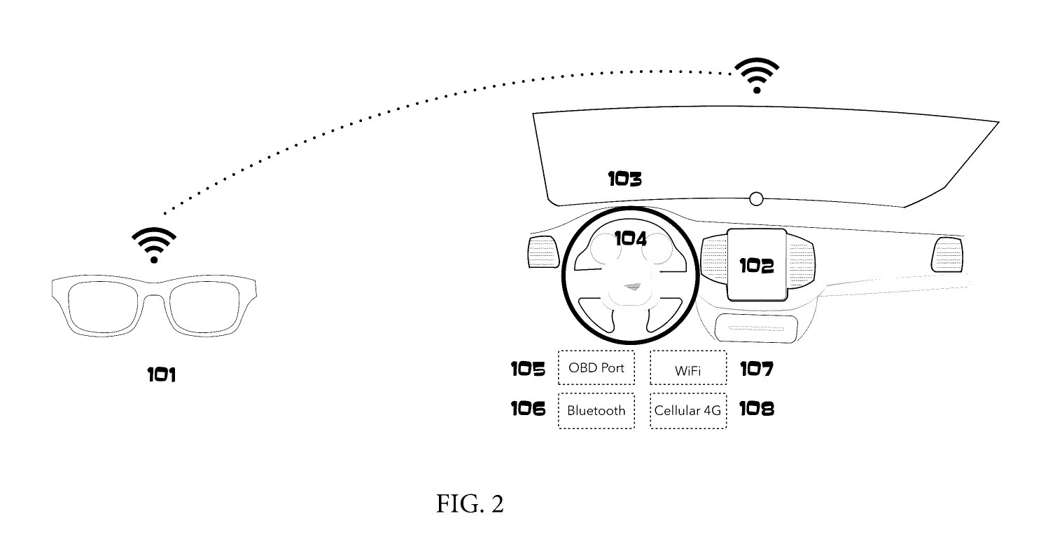

With reference to FIG. 2, one can see that there are other ways for the system to connect a vehicle. Some of these ways included connecting a module to the OBD port 105, Bluetooth 106, Wi-Fi 107, and a cellular network 108. In the cases of 106, 107, and 108 there is often a modem that has been placed in most modern cars so that a mobile device such as a pair of electronic eyewear 101 can interface with the vehicle. 106 however has typically been left to remotely access via and OBD scanner or a closed system by the manufacturer such as On-Star by General Motors. However, in the future these systems may be opened to developers who would like to access the OBD system wirelessly. Currently a third-party device 420 may be added to the vehicle that allows for one to interface with the vehicle's OBD system or telematics system. One such system is the Automatic Module by Automatic Labs. The Automatic module plugs into a vehicles OBD port 105 (also shown at 437 in FIG. 4) and is able to wirelessly output or log data such as vehicle speed and engine temperature or more sophisticated functions such as moving a phone to a ‘do not disturb’ when the vehicle is in motion or calling emergency services when the an airbag deployment sensor has been activated.

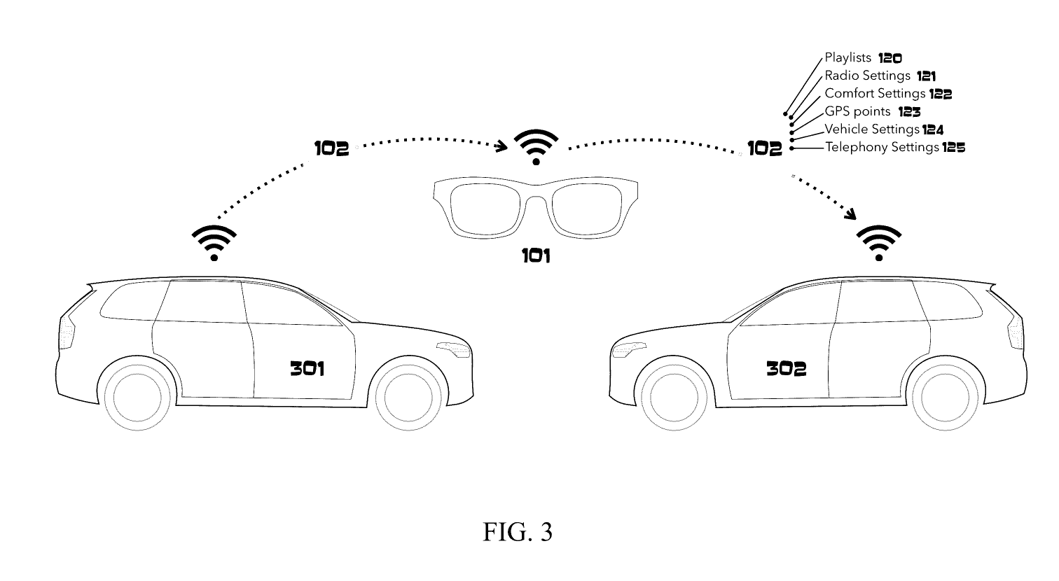

With reference to FIG. 3, the system can also be used to transmit data between vehicle modules of vehicles that are not otherwise capable of vehicle-to-vehicle communication. In this example the electronic eyewear acts as storage device on a ‘sneaker net’ that is wireless enabled. In this embodiment, settings such as seating position, radio presets, or navigational waypoints can be uploaded from a first vehicle, stored in 101, and downloaded to a second vehicle 302.

FIG. 4 illustrates an example of an electronic system of the invention where the electronic eyewear hardware 410 comprising memory 414, a processor 415, and a display system 411 (further comprising a display 412 and a driver 413) can communicate directly with a vehicle module such as a vehicle's telematics system 430 wirelessly via a wireless module 416 comprising a wireless antenna. FIG. 4 also illustrates an embodiment wherein the vehicle module includes a third party device such as phone or module that includes memory 421 along with the vehicle's telematics system 430. In this embodiment, the electronic eyewear hardware 410 can communicate with the vehicle through the third party device 420. The third-party device 420 can plug in directly to 430 or communicate with 430 wirelessly via a wireless module 422 and a wireless module 436. Data from memory 440 of the telematics system 435, such as data from the instruments 433 or infotainment/climate systems 434, can be communicated wirelessly to the electronic eyewear hardware 410.

In certain applications, a software developer may choose to use 101 with a secured third-party device. In this case, the invention has an onboard authentication system that scans the eye. As every eye is different this adds a primary level of security. For individuals that are in the public eye (such as celebrities and politicians) and have numerous photos available, there may be a concern that someone may be able to lift an ‘eye print’ from a high resolution photo. An additional level of security is that the images used in this system can have a very high resolution and a proprietary aspect ratio, and the system can use a comparison of infrared images and conventional digital photos in order to authenticate. This system also may use a series of images or a video analysis of a person's eye to authenticate the user.

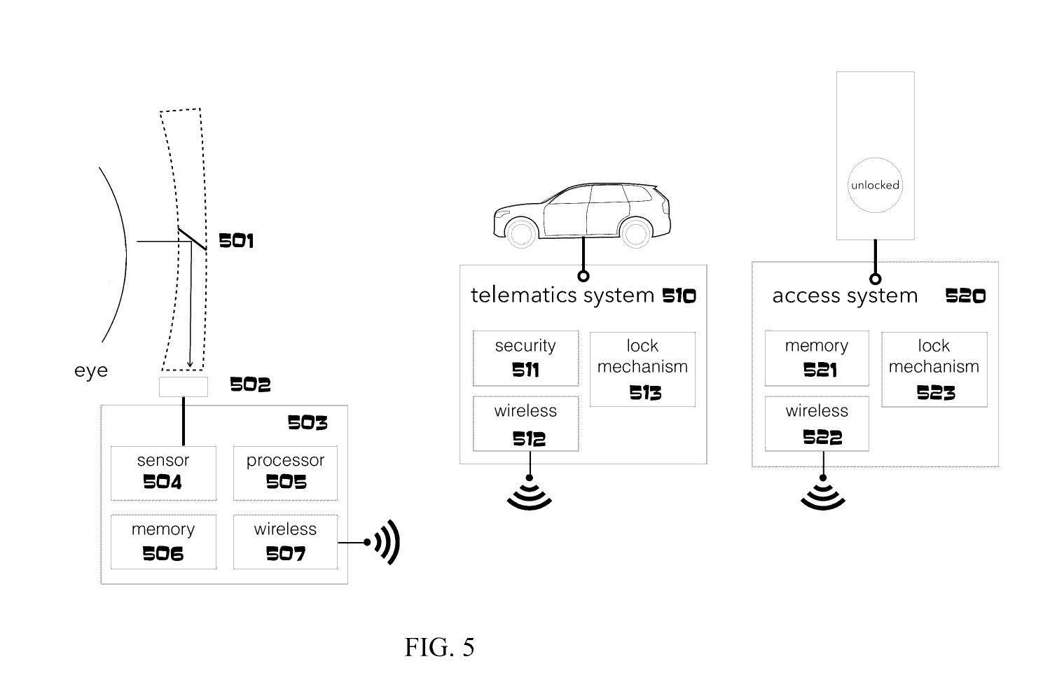

FIG. 5 is an illustration of hardware that may be needed in accordance with such an embodiment. A reflective surface 501 redirects light through an optical element 502 such as a lens, waveguide, or fluid and into an image sensor 504 of a biometric matching system 503. From there the image from sensor is processed in a processor 505 and is either stored in memory 506 or is compared to an image that is stored in memory 506. If the match is positive a wireless antenna 507 will transmit a security credential. This credential may be sent to any third party device but by way of example only FIG. 5 shows one credential being sent a vehicle's telematics system 510 (having security module 511, lock mechanism 513, and wireless module 512) and another being sent to a home's access system 520 (having memory 521, lock mechanism 523 and wireless module 522). In both of the illustrated cases the goal being to lock or unlock a device. Note that both 510 and 520 have a wireless modem to transmit and receive data such as security credentials.

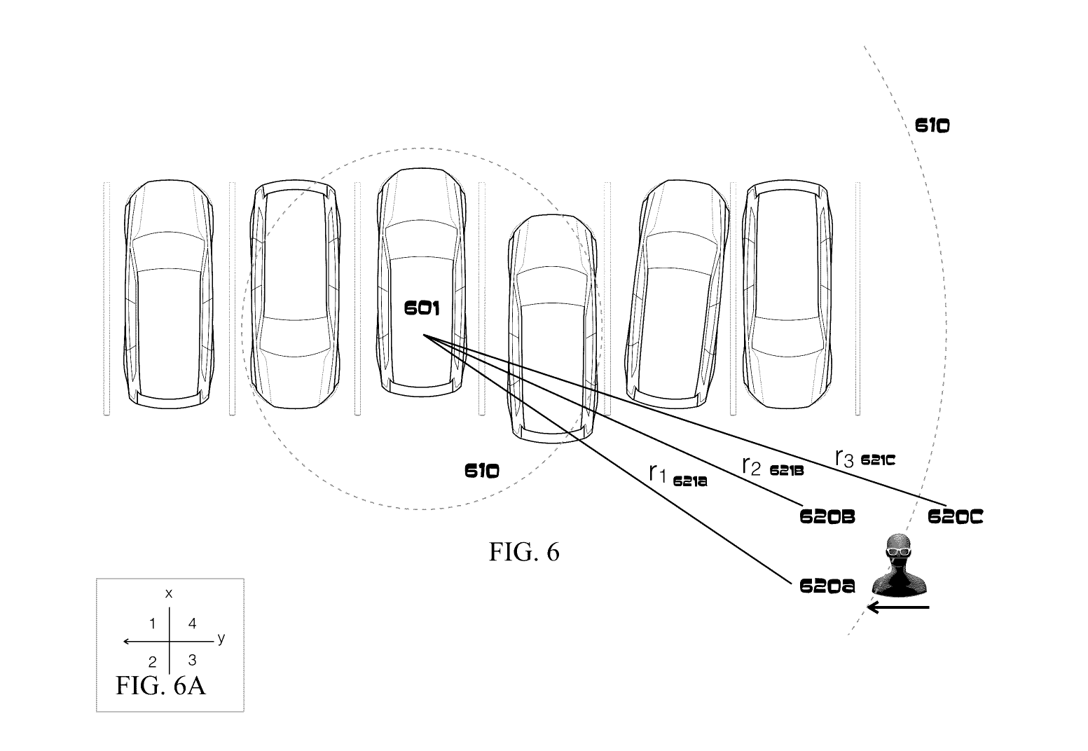

Another function of the electronic eyewear 101, is its ability to convey distances and waypoints to a user in real time. For example, FIG. 6 shows a trilateration function being performed with goal of assisting a user to find the location of wireless enabled object 601, which by way of example only is illustrated as a car that is out of view because a second car is in the user's line of sight. In FIG. 6, the user is wearing an embodiment of 101 that feature 3 on board wireless sensor 620A, 620B, and 620C. Initially one of these three sensors will send a first signal to 601 to determine if the user is in range. If the user is, 601 will send a back a signal confirming that is ‘awake’. At that point 620A, 620B, 620C will simultaneously send a signal to 601 and 601 will send the signal back to 101. 101 will then calculate the amount of time that has passed and perform additional calculation to determine the distance 621A, 621B, and 621C also illustrated as radii r1, r2, and r3. Looping this system software can simply output prompts that let you know if you going in the correction direction. For example, looking FIG. 6 again, one can see that 621B has the shortest radius. Assuming that the direction of travel is from right to left on the illustration, one can deduce that 601 is in front and towards the right of the user (quadrant 1 on FIG. 6a). If 621A were shortest, one would deduce that the 601 is in front and to the left (quadrant 2 on FIG. 6a). If 621C were shortest is would mean that 601 is behind the user (in either quadrant 3 or 4 of FIG. 6a).

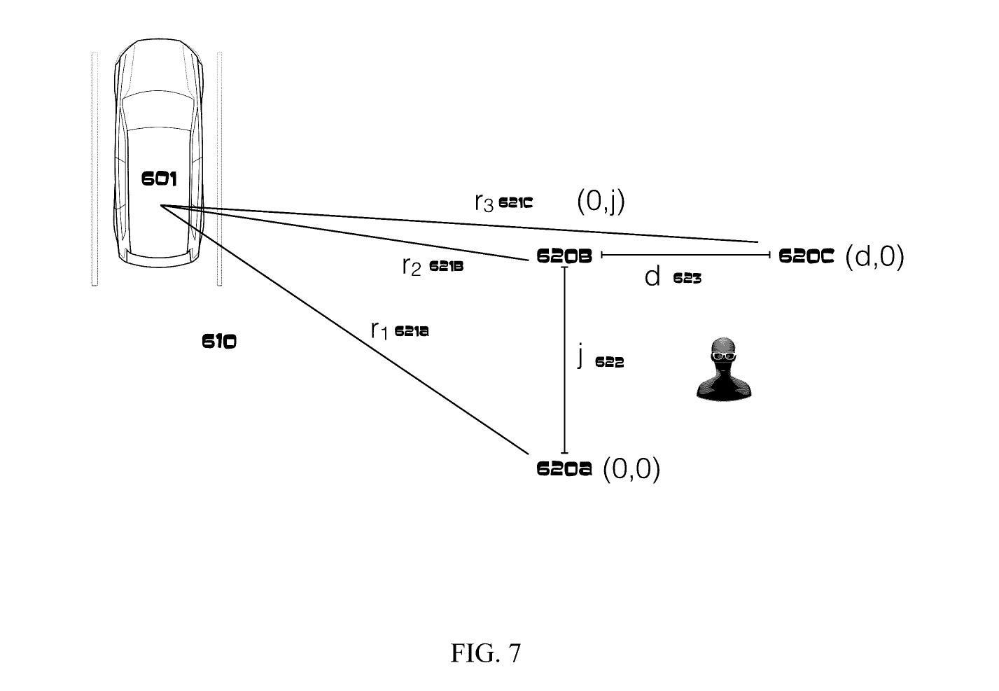

FIG. 7 shows a more advanced version of the function of FIG. 6 that determines the coordinates of 601 with respect to the user. In this case the known coordinates of 620A, 620B, and 620C (with 620A residing at the origin) would be preloaded into the system. The distance between 620A and 620B is “j” or 622 the distance between 620B and 620 is “d” or 623. If one considers the points associated with 620A, 620B, 620C as center points to 3 sphere, they may described by the following equations:

r₁²=x²+y²+z²

r₂²=(x−d)²+y²+z²

r₃²=(x−d)²+(y−j)²+z²

The wireless enabled object 601 has coordinate (x,y,z) associated with that will satisfy all three equations. In order find said coordinate the system first solves for x by subtracting r₁, and r₂.

r₁²−r₂²=x²−(x−d)²

Simplifying the above equation and solving for x yields the equation:

$$x = \frac{{r}_{1}^{2} - {r}_{2}^{2} + {d}^{2}}{2 d}$$

In order to solve for y, one must solve for z in the first equation and substitute into the third equation.

z²=r₁²−x²−y²

r₂³=(x−d)²+(y−j)²+r₁²−x²−y²

### Simplifying:

$${r}_{3}^{2} = ( {x}^{2} - 2 xd + {d}^{2} ) + ( {y}^{2} - 2 yj + {j}^{2} ) + {r}_{1}^{2} - {x}^{2} - {y}^{2}$$

$$y = \frac{- 2 xd + {d}^{2} + {j}^{2} + {r}_{1}^{2} - {r}_{3}^{2}}{2 j}$$

$$y = \frac{{r}_{1}^{2} - {r}_{3}^{2} + {d}^{2} + {j}^{2}}{2 j} - \frac{d}{j} x$$

At this point x and y are known, so the equation for z may simply be rewritten as:

z=±\sqrt{r₁²−x²−y²}

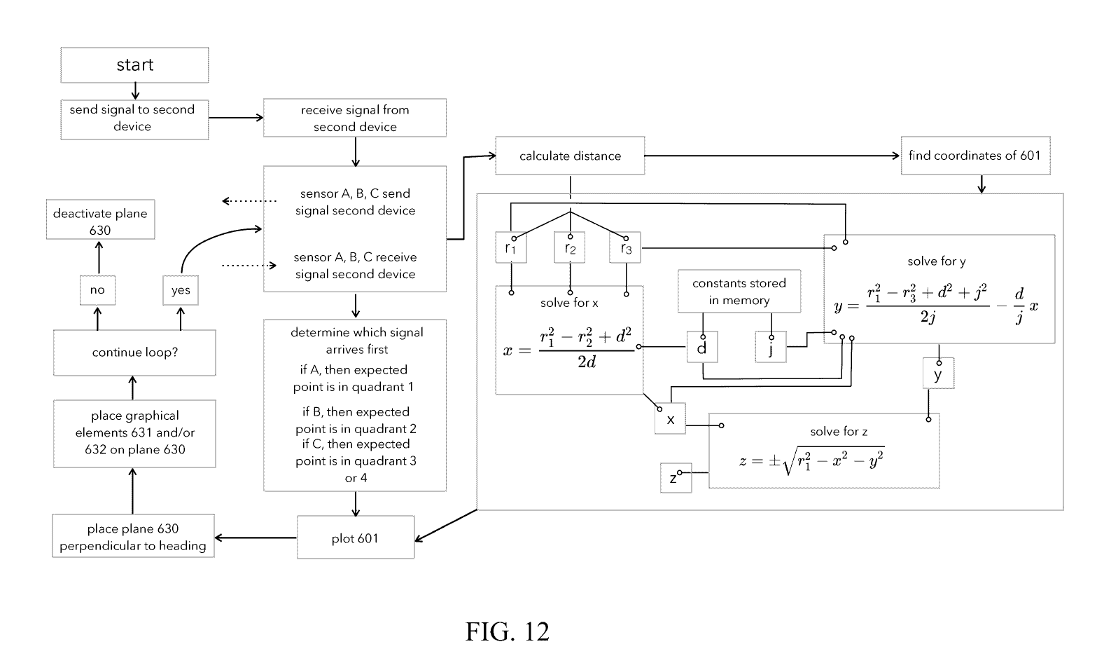

Since this is not an absolute value it is possible for there to be more than one solution. In order to find the solution, the coordinates can be matched to the expected quadrant which ever coordinate does not match the expected quadrant is thrown out. FIG. 12 illustrates how the above operations may be looped with software.

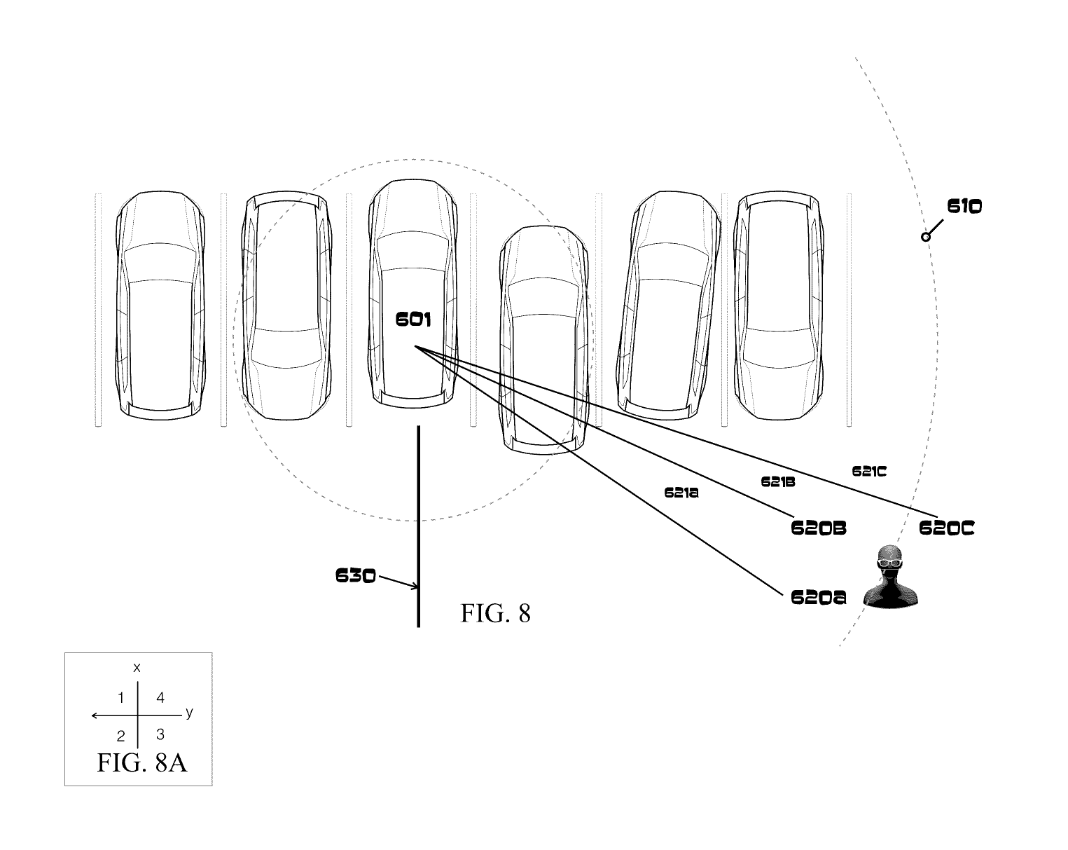

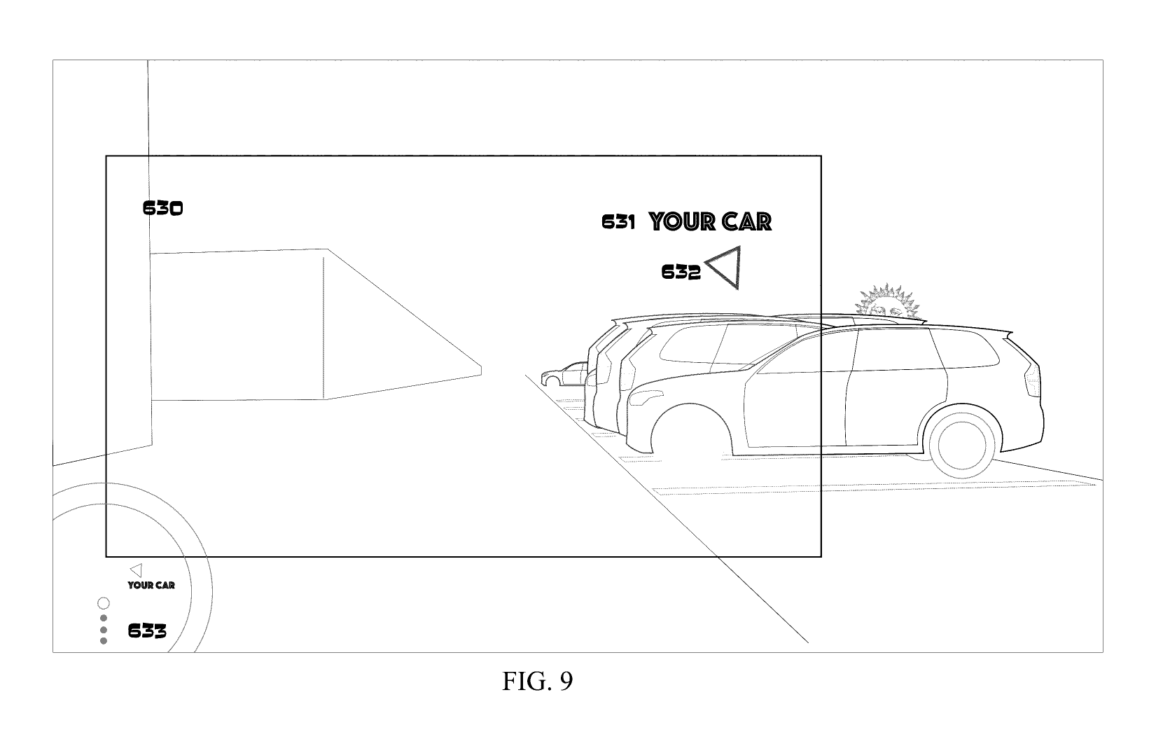

FIGS. 8 and 9 illustrate how a virtual plane 630 can be projected out into space that may be used to draw graphics on. In this case 630 is a projected x-z plane a distance y in front of the user. Now turning to FIG. 9, since 630 is now being projected as if it coincident with 610, one may choose to draw a waypoint 632 and some character based data to aid a person in finding 630. To aid the user further, a mini map 633 may be displayed that shows via 631 where 601 is located relative to the user.

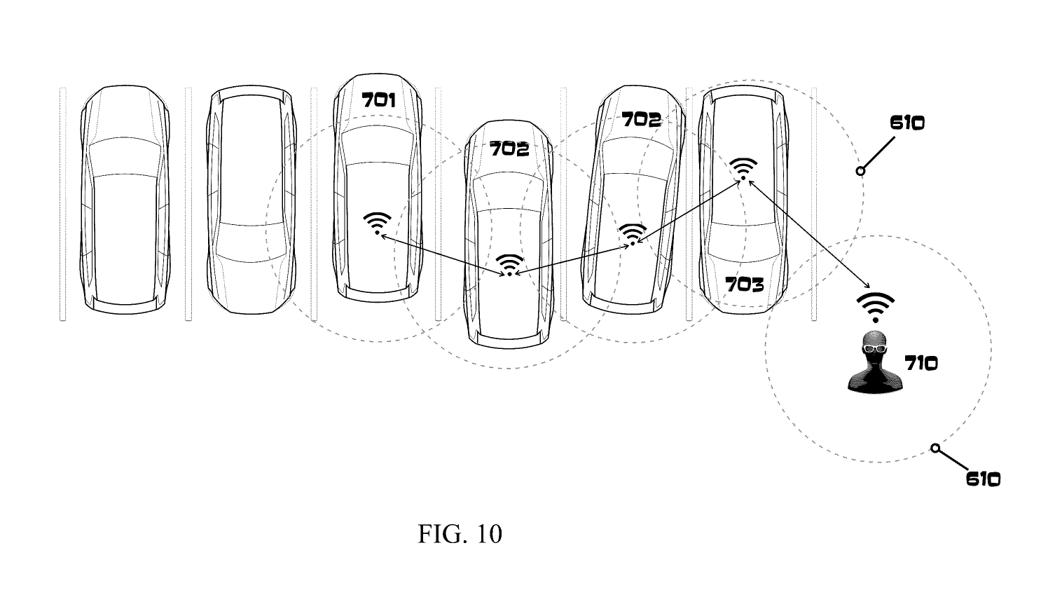

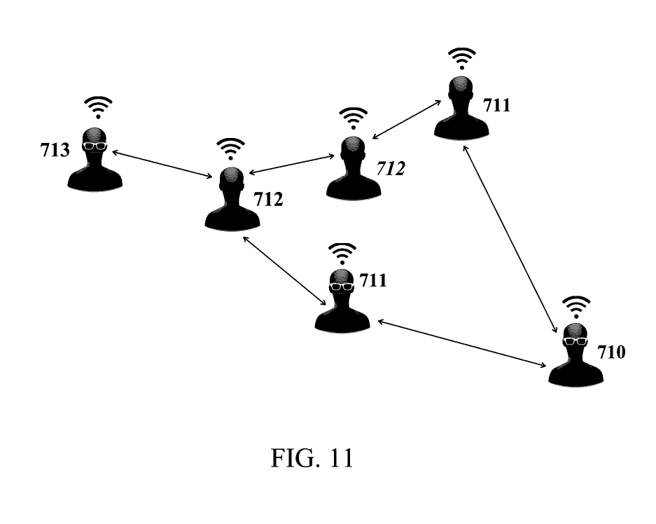

There may be a time when a user 710 is out of range of 601 but may be in range 610 of another wireless enable device. FIG. 10 illustrates how a type of mesh work may be used to indicate to a user where 601 is located. By way of example only, the case illustrated in FIG. 10 shows multiple vehicles in a parking lot that are wirelessly enabled. In this case, a first car 703 communicates with a first intermediate vehicle 702, which then communicates with a second intermediate vehicle 702 that is in communication with desired car 701. In this case the electronics eyewear can process this information stating “your vehicle is on the right four vehicles away”. FIG. 11 shows a similar application of the invention where it is being used in an environment where there are multiple people using wireless devices such as smartphones, wearables or laptops. In this application 710 is sharing data with multiple first devices 711. The 711's are in communication with multiple secondary devices 712 that are also in contact with the desired device 713. Some of the methods described above can be used to display where the desired device is located with a waypoint or prompts such as “ahead about 10 steps and to the right”. It must also be noted that techniques described above to inherently rely on a satellite based GPS system, but rather the system can create a localized positioning system using Wi-Fi, Bluetooth, Zigbee or other ad hoc networks as this plot coordinates on the earth that relative to the user 710, whereas most satellite-based GPS assigns coordinate to user 710 relative to earth.

In some embodiments, the eyewear 101 and camera on the eye wear can be used in conjunction with one or more camera located outside of the eyewear. For example, a set of security cameras in a building, or cameras on one or more smart phone could to provide additional images to one produced by the eyewear 101 camera, that in combination may be used to examine a scene to find an object of a known shape or size. The information about the scene could then be displayed on the display systems of the eyewear. This could include complex 3D images, or simple text instructions regarding work to be done or performed in the scene. Information regarding known hazards in a scene may also be provided.

The cameras can be used to produce 3D images of the objects in the scene for later rendering. The images from multiple cameras might also be used in triangulation algorithms to locate objects in a scene relative to stored information regarding the said scene and objects in that scene.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

1. A system for sharing data between a vehicle and electronic eyewear, comprising:
a head-worn electronic eyewear device comprising a wireless communication module and an audio or visual system configured to communicate information received via the wireless module to a wearer of the head-worn electronic eyewear device;
a vehicle module associated with and in communication with a vehicle, said vehicle module being configured to communicate wirelessly with said head-worn electronic eyewear device, either directly or through a third-party device, such that vehicle data is communicated to the wireless module of the head-worn electronic eyewear device for communication to the wearer of the head-worn electronic eyewear device.

2. The system of claim 1 where the vehicle module comprises the third-party device and the third-party device is configured to access the vehicle's OBD bus or CAN system.

3. The system of claim 1 where the vehicle module comprises the third-party device and the third-party device is configured to access a vehicle or home's security or access system.

4. The system of claim 1, where the vehicle module comprises the third-party device and the third-party device is configured to access the vehicle's infotainment system.

5. The system of claim 1, where the head-worn electronic eyewear device comprises a display.

6. The system of claim 1, where the head-worn electronic eyewear device and the vehicle module are configured such that the wearer of the head-worn electronic eyewear device sees information rear camera or front camera of the vehicle.

7. The system of claim 1, where the vehicle module is configured to send visual or audio output from a park assist, collision warning or avoidance system associated with the vehicle to the head-worn electronic eyewear device.

8. The system of claim 1, where the vehicle module is configured to send data from a vehicle telematics system or GPS system to the wearer of the head-worn electronic eyewear device.

9. The system of claim 1, where vehicle settings are stored in the head-worn electronic eyewear device.

10. The system of claim 9, where the vehicle settings comprise at least one setting selected from the set consisting of: radio station settings, audio playlists, suspension settings, transmission settings, light settings, seating position, or mirror settings.

11. A system, comprising:
a head-worn device comprising a wireless communication module;
a first vehicle module associated with a first vehicle and configured to communicate vehicle settings data wirelessly to the head-worn device either directly or through a third-party device;
said head-worn device being configured to store said vehicle settings data and later communicate said vehicle settings data to a second vehicle module associated with a second vehicle, said second vehicle module being configured to receive said vehicle settings data wirelessly either directly or through a third-party device and to utilize said vehicle settings data in operation of at least vehicle system onboard said second vehicle.

12. The system of claim 11, where the vehicle settings data comprises at least one data type selected from the set consisting of: radio station data, audio playlist data, suspension settings data, transmission settings data, light settings data, seating position data, or mirror settings data.

13. The system of claim 11, where said vehicle settings data comprises data from a telematics system or GPS system associated with the first vehicle and where the system is configured to send said vehicle settings data to the head-worn device and later upload said vehicle settings data to said second vehicle's telematics or GPS system.

14. The system of claim 11, where the head-worn device is a head-worn display.

15. A system for authenticating a user, comprising:
a head-worn device comprising an on-board imaging system configured to capture and store a current image of at least one of a wearer's eyes to be compared to an original image or video of the wearer's eye as a form of authentication;
a second device configured to communicate with said head-worn device and permit access upon matching of said current image to said original image.

16. The system of claim 15, where the current image comprises a still image.

17. The system of claim 15, where the current image comprises a video.

18. The system of claim 15, where the original image is stored in the second device.

19. The system of claim 15, where the original image is stored in the head-worn device.

20. The system of claim 15, where the original image is stored in a third-party device.

21. A system comprising:
a first wireless-enabled device, the device having three or more sensors on board;
a second wireless-enabled device;
wherein the first wireless-enabled device is configured to utilize data from the three or more sensors in a trilateration function to locate the second wireless-enabled device.

22. The system of claim 21, where the first wireless enabled device comprises electronic eyewear.

23. The system of claim 21, where the first wireless-enabled device comprises a device configured to provide an augmented reality environment.

24. The system of claim 21, where the first wireless-enabled device is a vehicle.

25. The system of claim 21 where the data is plotted on virtual plane in front of the user.

26. The system of claim 25 where a waypoint, symbol, marker or other character is mapped to said virtual plane.

27. The system in accordance with claim 25, where the first wireless-enabled device is configured to utilize a mini map to indicate a position of the second wireless enabled device from a perspective that is above the user.
